(19) United States
(12) Patent Application Publication
(10) Pub. No.: US 2021/0272047 A1
(43) Pub. Date: Sep. 2, 2021

(54) METHOD AND TERMINAL FOR MANAGING WORK SCHEDULE OF EACH EMPLOYEE AUTOMATICALLY

(71) Applicant: Skimcorp International LLC, Goyang-si (KR)

(72) Inventor: Steven Daehyun KIM, Calabasas, CA (US)

(73) Assignee: Skimcorp International LLC, Goyang-si (KR)

(21) Appl. No.: 17/187,428

(22) Filed: Feb. 26, 2021

(30) Foreign Application Priority Data
Feb. 28, 2020 (KR) 10-2020-0024972

(51) Int. Cl. G06Q 10/06; G06Q 10/10; G06F 17/18; G06N 7/00

(52) U.S. Cl. CPC G06Q 10/063116; G06N 7/00; G06F 17/18; G06Q 10/1091

(57) ABSTRACT

A method performed by a terminal for managing a work schedule of each employee automatically according to an embodiment of the present disclosure includes reading past work history data for a plurality of weeks of a corresponding employee, predicting total working hours of a following week by summing average weekly working hours and trend adjustment values for the plurality of weeks, allocating the predicted total working hours of the following week for each day of the week based on a time distribution for each day of the week, and allocating the allocated time for each day of the week based on a distribution for each working hour.

### CROSS-REFERENCE TO RELATED APPLICATION

A claim for priority under 35 U.S.C. § 119 is made to Korean Patent Application No. 10-2020-0024972 filed on Feb. 28, 2020 in the Korean Intellectual Property Office, the entire contents of which are hereby incorporated by reference.

### BACKGROUND

### 1. Technical Field

The present disclosure relates to a method and a terminal for managing a work schedule of each employee automatically, and more specifically, to a method and a terminal for predicting and allocating the working hours of a following week of a corresponding employee based on past work history data managed for each employee.

### 2. Description of Related Art

Existing methods for scheduling and managing part-time employees include management methods using papers, management methods using spreadsheets, management methods using calendars, and other management methods via application programs such as applications of PCs or smartphones.

In the case of the existing scheduling methods, part-time employees were generally managed through the following methods.

First, an employee directly informs a manager of the schedule of the day set during the week, and the manager selects the best employee for the day and time. Also, the process is repeated on a daily and weekly basis for all employees.

In the case of the above method, in general, there was an inconvenience of having to select a suitable employee by the manager and manually select a suitable time for the employee.

As related technology for supplementing such a scheduling function, there is a technology that alerts a manager to a warning when an employee has worked for more than a standard working hour, when the time between employees overlaps, and when the working allowance is exceeded. However, even in this case, there is a deficiency that a manager should continuously manage and supervise whether the prescribed work standards are violated.

As another technology, there is technology for setting working rules, including possible working hours of employees, peak time working hours, employee movements, and sales, and then managing the schedule according to the regulations. However, even in this case, there was a deficiency that a manager had to manually modify and supplement the relevant rules every time depending on the staffing level, the staff competency, or the situation of a store.

### SUMMARY

Various aspects of the present disclosure provide a method and a terminal for managing a work schedule of each employee automatically that predicts total working hours of a following week of a corresponding employee based on past work history data managed for each employee, and predicts and allocates time for each working hour within the corresponding day of the week after allocating the time for each day of the week of the following week based on the predicted total working hours.

The aspects of the present disclosure are not limited to the above-mentioned aspects, and other aspects, which are not mentioned, will be clearly understood by those skilled in the art from the following description.

A method performed by a terminal for managing a work schedule of each employee automatically according to a first aspect of the present disclosure includes reading past work history data for a plurality of weeks of a corresponding employee, predicting total working hours of a following week by summing average weekly working hours and trend adjustment values for the plurality of weeks, allocating the predicted total working hours of the following week for each day of the week based on a time distribution for each day of the week, and allocating the allocated time for each day of the week based on a distribution for each working hour.

In one embodiment, the predicting of the total working hours of the following week by summing the average weekly working hours and trend adjustment values for the corresponding employee may include calculating average weekly working hours for a plurality of pre-set past weeks for the corresponding employee, calculating trend adjustment values based on the total working hours for the plurality of weeks, and predict the total working hours of the following week of the corresponding employee by summing the average weekly working hours and the trend adjustment values.

In one embodiment, the calculating of the trend adjustment values based on the total working hours for the plurality of weeks may include calculating a median value by quantifying the plurality of weeks, calculating a median value of working hours for each week for the plurality of weeks, and calculating the trend adjustment value based on a least square method (LSM) for each of the calculated median values.

In an embodiment, the calculating of the trend adjustment value based on a least square method (LSM) for each of the calculated median values may include calculating a difference between the median value of the plurality of weeks and a numerical value, calculating a difference between the median value of the working hours for each week of the plurality of weeks and the working hours for each week, and calculating the trend adjustment value based on a result of a square operation of a difference between the median value of the plurality of weeks and a numerical value and a result of a multiplication operation of each difference.

In one embodiment, the allocating of the predicted total working hours of the following week for each day of the week based on a time distribution for each day of the week may include calculating a time distribution for each day of the week for the entire plurality of weeks, applying a weighted value set for each week to the time distribution for each day of the week, and allocating the predicted total working hours based on the time distribution for each day of the week to which the weighted value is applied.

In an embodiment, the allocating of the allocated time for each day of the week based on a distribution for each working hour may include calculating a time distribution for each working hour for a specific day of the week of the plurality of weeks, applying a weighted value set for each week to the time distribution for each working hour of the specific day of the week, and allocating time for each working hour based on the time distribution for each working hour to which the weighted value is applied.

In an embodiment, the weighted value may be a weighted value to which a higher weighted value is given to a recent week among the plurality of weeks.

In addition, the terminal for managing a work schedule of each employee automatically according to a second aspect of the present disclosure includes a memory in which a program for automatically managing a work schedule for the corresponding employee is stored, and a processor for executing a program stored in the memory. Specifically, the processor reads past work history data for a plurality of weeks of a corresponding employee in response to the execution of the program, predicts total working hours of a following week by summing average weekly working hours and trend adjustment values for the plurality of weeks, allocates the predicted total working hours of the following week for each day of the week based on a time distribution for each day of the week, and allocates the allocated time for each day of the week based on a distribution for each working hour.

In addition, another method for implementing the present disclosure, another system, and a computer-readable recording medium for recording a computer program for executing the method may be further provided.

According to an embodiment of the present disclosure, it is possible to automatically provide the best recommended schedule for all employees in a store every week through predictive scheduling.

In particular, by implementing predictive scheduling in software, automatic scheduling for each store is possible, and by reducing the time required for manual scheduling, review time and cost for the best scheduling can be minimized

The advantages of the present disclosure are not limited to the above-mentioned advantages, and other advantages, which are not mentioned, will be clearly understood by those skilled in the art from the following description.

### BRIEF DESCRIPTION OF THE DRAWINGS

FIG. 1 is a diagram for explaining scheduling of an employee's work schedule according to the present disclosure.

FIG. 2 is a flowchart of a method for managing a work schedule of each employee automatically according to the present disclosure.

FIG. 3A is a diagram for explaining average weekly working hours according to the present disclosure.

FIG. 3B is a diagram for explaining trend adjustment values according to the present disclosure.

FIG. 4A is a diagram for explaining a time distribution for each day of the week to which weight adjustment is not applied according to the present disclosure.

FIG. 4B is a diagram for explaining weighted values according to the present disclosure.

FIG. 4C is a diagram for explaining a time distribution for each day of the week to which weight adjustment is applied according to the present disclosure.

FIG. 4D is a graph illustrating the results before and after application of weighted values according to the present disclosure.

FIG. 5A is a diagram for explaining a time distribution of a specific day of the week to which weight adjustment is not applied according to the present disclosure.

FIG. 5B is a diagram for explaining a time distribution of a specific day of the week to which weight adjustment is applied according to the present disclosure.

FIG. 5C is a graph illustrating the results before and after application of weighted values according to the present disclosure.

FIG. 6 is a diagram for explaining a terminal for managing a work schedule of each employee automatically according to the present disclosure.

FIG. 7 is a diagram illustrating an example of an application executed in a terminal for managing a work schedule of each employee automatically according to the present disclosure.

### DETAILED DESCRIPTION

Advantages, features, and methods of accomplishing the same of the preset disclosure will become apparent with reference to embodiments described in detail below together with the accompanying drawings. However, the present disclosure is not limited by embodiments disclosed hereinafter, and may be implemented in various forms. Rather, these embodiments are provided to so that this disclosure will be through and complete and will fully convey the scope of the present disclosure to those skilled in the technical field to which the present disclosure pertains, and the present disclosure will only be defined by the appended claims.

Terms used in the specification are used to describe embodiments of the present disclosure and are not intended to limit the scope of the present disclosure. In the specification, the terms of a singular form may include plural forms unless otherwise specified. The expressions “comprise” and/or “comprising” used herein indicate existence of one or more other elements other than stated elements but do not exclude presence of additional elements. Like reference denotations refer to like elements throughout the specification. As used herein, the term “and/or” includes each and all combinations of one or more of the mentioned components. It will be understood that, although the terms “first”, “second”, etc., may be used herein to describe various components, these components should not be limited by these terms. These terms are only used to distinguish one component from another component. Accordingly, a first component mentioned below could be termed a second component without departing from the technical ideas of the present disclosure.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

The present disclosure relates to a method and a terminal 100 for managing a work schedule of each employee automatically. Hereinafter, exemplary embodiments of the present disclosure will be described in detail with reference to the accompanying drawings.

The employee in the present disclosure targets part-time employees who work through selection of a specific day of the week or a specific time, but is not limited thereto.

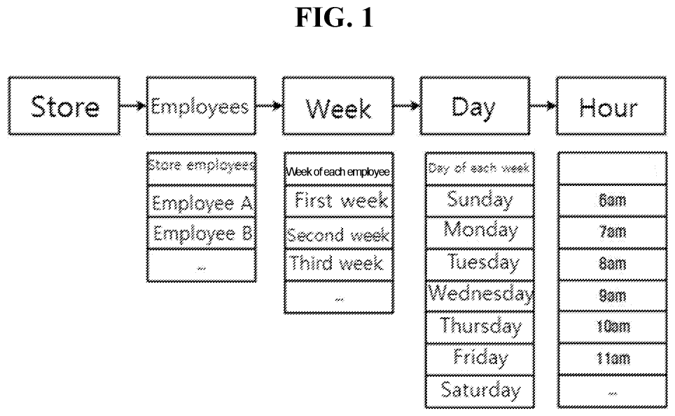

FIG. 1 is a diagram for explaining scheduling of an employee's work schedule according to the present disclosure.

In general, there are several considerations for scheduling an employee's work schedule.

For example, there are several employees working at a store, and each employee works over several weeks. In addition, employees work on specific day(s) of the week, and work at a specific time every day.

In order to obtain the entire schedule for the following week through these considerations, the calculation should be repeated using the same method every day for all employees as shown in FIG. 1.

First, if several employees, such as employees A and B, work in a specific store, the manager should select a specific employee to plan a schedule.

Then, the employee's work plan is scheduled by checking each week and the day of the week and the time of each day for the employee.

In this way, in order to schedule a work plan for employees in a store, the manager had to manually manage all the schedules of the employees.

The method and the terminal 100 for managing a work schedule of each employee automatically according to an embodiment of the present disclosure are capable of predicting future scheduling requests for employees in advance based on past work history data managed for each employee, and automating manual recurring scheduling performed by store managers.

In other words, by automatically suggesting the employee's work schedule through a predictive scheduling technique or automatically scheduling a work plan every week, it is possible to quickly set a schedule most suitable for the characteristics of a store schedule.

The manager who schedules an employee work should consider tangible and non-tangible factors.

The tangible factors to consider here include costs, employee skills, working days, employee preferred hours, labor laws and regulations, and the non-tangible factors to consider include confidence in employees, level of teamwork with others, manager's will to time allocation, and a manager's style for store operation (for example, the minimum number of employees determined to be necessary when operating a store).

Due to many of these factors, especially the non-tangible factors, when the manager ultimately decides on the work schedule of the employees, the schedule essentially reflects the manager's decisions, style and intentions. Accordingly, the past work history data for a plurality of weeks reflecting such information becomes basic data for predictive scheduling that is most suitable for the manager and the store the manager operates.

According to an embodiment of the present disclosure, based on past work history data, predictive scheduling may be performed in consideration of tangible and non-tangible behaviors of a manager.

The predictive scheduling result generated in this way does not require rules or thresholds, and is naturally continuously updated with a new schedule every week. For example, as a store becomes larger in size and busy, the working hours of employees increase. If the predictive scheduling result data is used, it may be used again to predict the following week of the data.

In addition, according to an embodiment of the present disclosure, there is an advantage that it can be directly applied to a system or mobile application requiring self-adjustment scheduling.

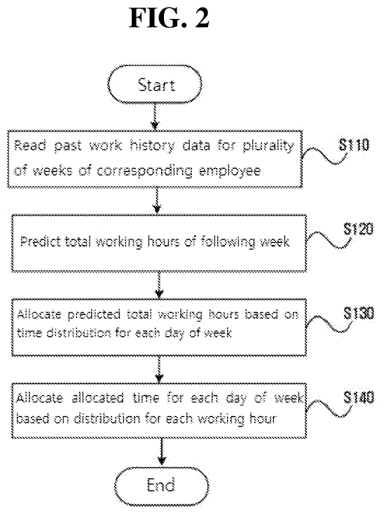

FIG. 2 is a flowchart of a method for managing a work schedule of each employee automatically according to the present disclosure.

Referring to FIG. 2, the method performed by a terminal 100 for managing a work schedule of each employee automatically includes reading past work history data for a plurality of weeks of the corresponding employee (S110), predicting total working hours of the following week by summing average weekly working hours and trend adjustment values for the plurality of weeks (S120), allocating the predicted total working hours of the following week for each day of the week based on a time distribution for each day of the week (S130), and allocating the allocated time for each day of the week based on a distribution for each working hour (S140).

First, an embodiment of the present disclosure reads the past work history data for a plurality of weeks of the corresponding employee (S110).

In one embodiment, the past work history data is a schedule registered by a store manager for a plurality of weeks in the past set in advance, or a schedule in which time has elapsed after being automatically predicted by the terminal 100. In the example of the present disclosure, a plurality of weeks is described as 6 weeks, but is not necessarily limited thereto, and it goes without saying that it may be set in various ways such as 4 weeks or 8 weeks according to the type of industry or service.

The past work history data in an embodiment of the present disclosure is data registered by a store manager in consideration of not only a series of schedules for employees, but also items most suitable for the store, for example, labor costs, skill levels, busy times, and idle times. However, it is used as an important resource to predict future schedules.

Such past work history data may include time trend data, time distribution data, weekly working time trend data, and daily distribution data.

Time trend data is the trend of total hours worked during the days of the week. For example, if the total hours worked on Mondays for the last 6 weeks are 10 hours, 20 hours, 30 hours, 40 hours, 50 hours, and 60 hours, the trend every Monday is an increase of 10 hours every week.

The time distribution data is the distribution of hours worked based on a specific time, for example, 10 a.m., or 11 a.m., and the total hours worked on Mondays for the last 6 weeks are 2 hours from 1 p.m., 4 hours from 2 p.m., and 4 hours from 3 p.m., the time distribution is shown as ‘1 p.m.=20%,’ ‘2 p.m.=40%,’ and ‘3 p.m.=40%.’

The weekly working hours trend data is the trend of the total hours worked by an employee during the week. For example, if the total number of hours worked for the last 6 weeks is 10 hours, 15 hours, 20 hours, 25 hours, 30 hours, and 35 hours, the weekly trend is an increase of 5 hours every week.

Finally, the daily distribution data shows the distribution of hours worked by day of the week. For example, if the total working hours for the last 6 weeks are 20 hours on Mondays, 10 hours on Tuesdays, and 20 hours on Wednesdays, the distribution is shown as ‘Monday=40%,’ ‘Tuesday=20%,’ and ‘Wednesday=40%.’

As such, according to an exemplary embodiment of the present disclosure, a schedule of the following week for each employee may be predicted by determining a working trend such as time per day and days per week, a working pattern, and a work distribution using past work history data.

Next, the total working hours (Predictive Week Total, TPR) of the following week are predicted by summing average weekly working hours (Historical Week Total, THI) and trend adjustment values (Adjustment: Trend, ATR) for a plurality of weeks (S120).

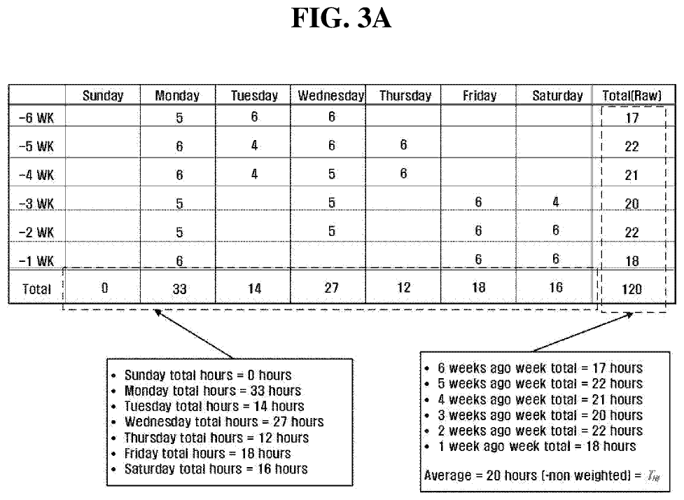

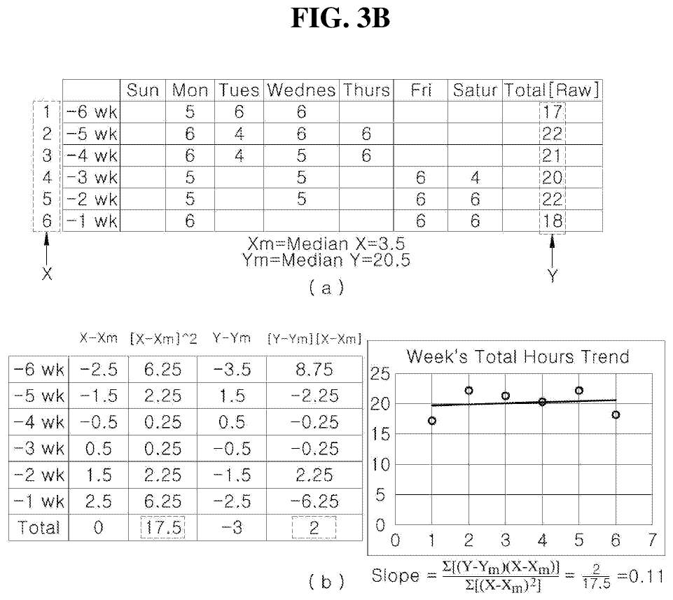

FIG. 3A is a diagram for explaining average weekly working hours, and FIG. 3B is a diagram for explaining trend adjustment values according to the present disclosure.

In one embodiment, in order to predict the total working hours (TPR) of the following week, an embodiment of the present disclosure first calculates the average weekly working hours (THI) for the past multiple weeks set in advance for the corresponding employee.

Referring to FIG. 3A, the working hours for each day of the week for the last 6 weeks based on the present time are 120 hours in total of 0 hour on Sundays, 33 hours on Mondays, 14 hours on Tuesdays, 27 hours on Wednesdays, 12 hours on Thursdays, 18 hours on Fridays, and 16 hours on Saturdays, or weekly working hours for each of 6 weeks are 120 hours in total of 18 hours in the past first week, 22 hours in the second week, 20 hours in the third week, 21 hours in the fourth week, 22 hours in the fifth week, and 17 hours in the sixth week based on the present time.

The average weekly working hours (THI) is an average without a weighted value applied to the sum of working hours for each day of the week for 6 weeks or 120 hours, which is the sum of working hours for each of 6 weeks, and is calculated as a total of 20 hours.

Then, after calculating the trend adjustment value (ATR) based on the total working hours for a plurality of weeks, the average weekly working hours (THI) and the trend adjustment values (ATR) are summed to predict the total working hours (TPR) of the following week of the corresponding employee.

Referring to FIG. 3B, in order to calculate the trend adjustment value (ATR), a plurality of weeks are first quantified and the median values (Median, Xm) of the numerical values are calculated. In an embodiment of the present disclosure, the median value means a value that is placed in the middle when each of the numerical values is arranged in order of size. For example, if the past first week is quantified as 6, the second week is quantified as 5, the third week is quantified as 4, the fourth week is quantified as 3, the fifth week is quantified as 2, and the sixth week is quantified as 1, the median value (Xm) of the quantified multiple weeks is 3.5.

Then, the median value (Ym) of each week's working hours for a plurality of weeks is calculated. For example, as of the present, if the working hours are 18 hours in the past first week, 22 hours in the second week, 20 hours in the third week, 21 hours in the fourth week, 22 hours in the fifth week, and 17 hours in the sixth week based on the present time, the median value (Ym) of each week's working hours for a plurality of weeks is calculated as 20.5 hours.

Then, for each calculated median value, a trend adjustment value is calculated based on LSM (Least Square Method).

In order to calculate the trend adjustment value based on the LSM, first, the difference between the median value (Xm) for a plurality of weeks and the numerical value (6 to 1) is calculated. In the example of FIG. 3B, the difference between the median value (Xm) and the numerical value (6 to 1) is calculated as 2.5 in the past first week, 1.5 in the second week, 0.5 in the third week, −1.5 in the fourth week, −2.5 in the fifth week, and −2.5 in the sixth week.

In addition, the difference between the median value (Ym) of each week's working hours for a plurality of weeks and the working hours of each week (18, 22, 20, 21, 22, 17) is calculated. In the example of FIG. 3B, the difference between the median value (Ym) and working hours for each week (18, 22, 20, 21, 22, 17) is calculated as −2.5 in the past first week, 1.5 in the second week, −0.5 in the third week, 0.5 in the fourth week, 1.5 in the fifth week, and −3.5 in the sixth week.

Thereafter, a trend adjustment value (ATR) is calculated based on a result of summing the difference between the numerical value (6 to 1) and the median value (Xm) for a plurality of weeks by a square operation and a result of a multiplication operation of each difference calculated above. In the example of FIG. 3B, the square operation of the difference between the median value (Xm) and the numerical value (6 to 1) is calculated as 6.25 in the past first week, 2.25 in the second week, 0.25 in the third week, 0.25 in the fourth week, 2.25 in the fifth week, and 6.25 in the sixth week, and the result of summing them is calculated as 17.5. In addition, a result of a multiplication operation of each difference calculated above ((Y−Ym)(X−Xm)) is calculated as −6.25 in the past first week, 2.25 in the second week, −0.25 in the third week, −0.25 in the fourth week, −2.25 in the fifth week, and 9.25 in the sixth week, and the result of summing them is calculated as 2. Accordingly, the trend adjustment value (ATR) is calculated as 0.11 by dividing each of the sum results.

After the trend adjustment value (ATR) is calculated, the average weekly working hours (THI) calculated previously and the trend adjustment value (ATR) are summed to predict the total working hours (TPR) of the following week of the corresponding employee. Accordingly, in the example above, the total working hours (TPR) of the following week is calculated as 20.11 hours, which is the sum of 20 hours and 0.11 hours.

In other words, 20.11 hours means the total working hours predicted for the employee in the following week after the 6-week period in the cases of FIGS. 3A and 3B.

Next, the predicted total working hours of the following week are allotted for each day of the week based on the time distribution for each day of the week (S130).

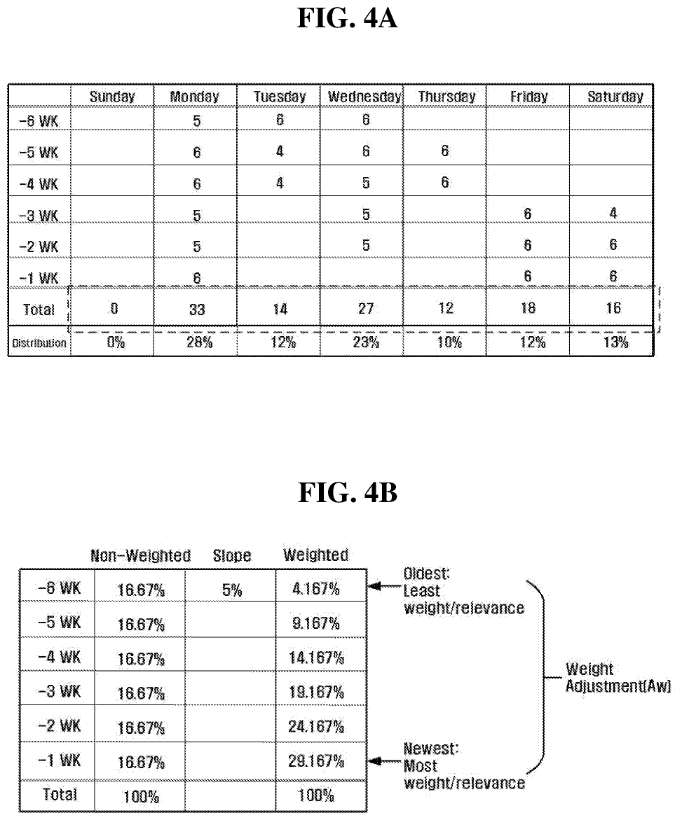

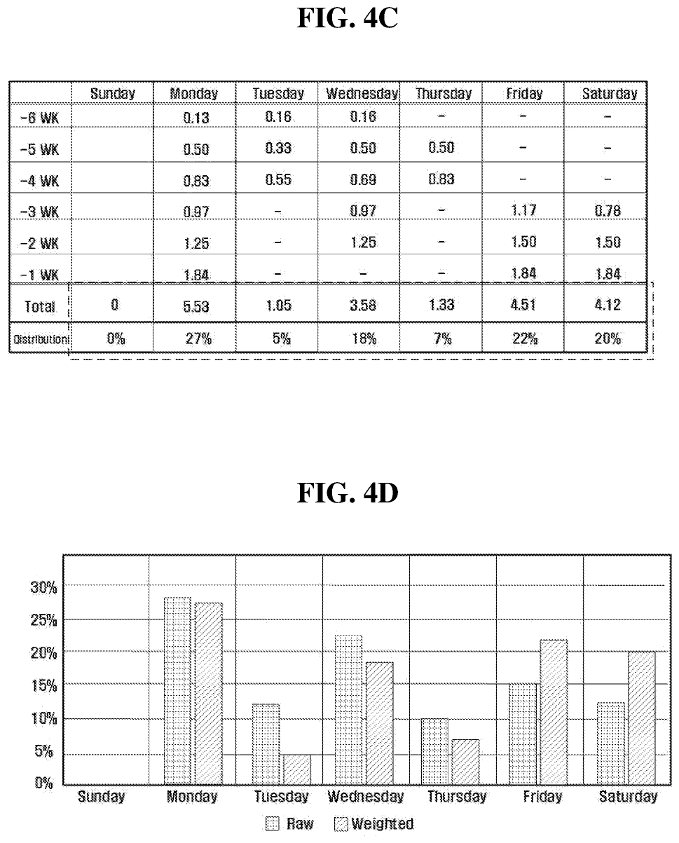

FIG. 4A is a diagram for explaining a time distribution (DHI) for each day of the week to which weight adjustment is not applied according to the present disclosure. FIG. 4B is a diagram for explaining weighted values (Aw) according to the present disclosure. FIG. 4C is a diagram for explaining a time distribution (DPR) for each day of the week to which weight adjustment is applied according to the present disclosure. FIG. 4D is a graph illustrating the results before and after application of weighted values according to the present disclosure.

In order to allocate the predicted total working hours (TPR) of the following week, an embodiment of the present disclosure first calculates a time distribution (DHI) for each day of the week for the entire plurality of weeks. As shown in FIG. 4A, the time distribution (DHI) for each day of the week is calculated as 0% for 0 hour on Sundays, 28% for 33 hours on Mondays, 12% for 14 hours on Tuesdays, 23% for 27 hours on Wednesdays, 10% for 12 hours on Thursdays, 15% for 18 hours on Fridays, and 13% for 16 hours on Saturdays.

Then, the weighted value (Aw) set for each week is applied to the time distribution (DHI) for each day of the week. FIG. 4B is an example of the weighted value (Aw). In an embodiment of the present disclosure, in order to more importantly evaluate the latest data, a linear weight value to which a higher weighted value is given to the recent week among a plurality of weeks may be applied. According to the example of FIG. 4B, when a linear slope of 5% is applied to the general weight value of 4.167%, the linear weighted value (Aw) is calculated as 29.167% in the past first week, 24.167% in the second week, 19.167% in the third week, 14.167% in the fourth week, and 9.167% in the fifth week, and 4.167% in the sixth week.

FIG. 4C shows an example of a time distribution (DPR) for each day of the week to which the weighted value (Aw) set for each week is applied to the time distribution (DHI) for each day of the week. When the weighted values for each week are summed, the time distribution (DPR) for each day of the week is calculated as 0% on Sundays, 27% on Mondays, 5% on Tuesdays, 18% on Wednesdays, 7% on Thursdays, 22% on Fridays, and 20% on Saturdays.

Then, the predicted total working hours of 20.11 hours are allocated based on the time distribution (DPR) for each day of the week to which the weighted value (Aw) is applied.

FIG. 4D is a graph illustrating the comparison results before and after application of weighted values (Aw). When the weight value (Aw) is applied, the prediction result is much more relevant and differentiated. For example, if a manager's recent behavior is to schedule an employee's work on Fridays and Saturdays, the relevance and differentiation will further increase if the schedule for Fridays and Saturdays is properly adjusted.

Next, the allocated time for each day of the week is allocated based on the distribution for each working hour (S140).

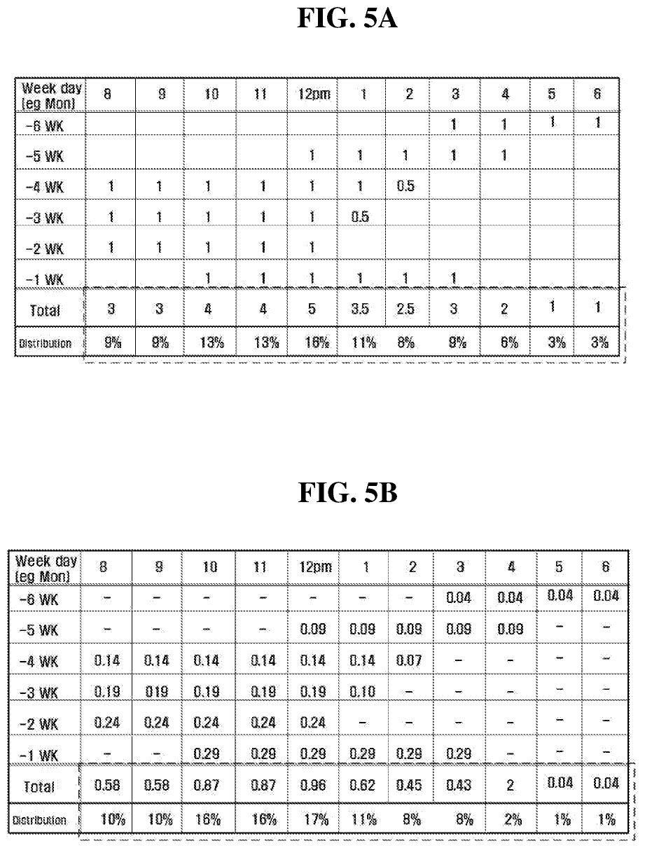

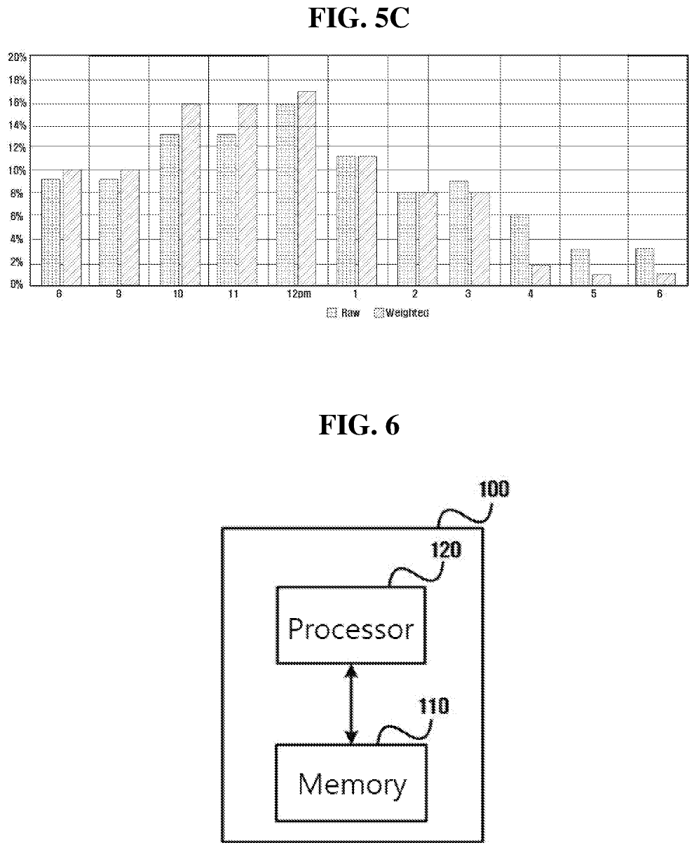

FIG. 5A is a diagram for explaining a time distribution of a specific day of the week to which weight adjustment is not applied according to the present disclosure. FIG. 5B is a diagram for explaining a time distribution of a specific day of the week to which weight adjustment is applied according to the present disclosure. FIG. 5C is a graph illustrating the results before and after application of weighted values according to the present disclosure.

In order to allocate the allocated time for each day of the week based on the distribution for each working hour, an embodiment of the present disclosure first calculates a time distribution for each working hour for a specific day of the week for a plurality of weeks. The example of FIG. 5A shows the time-specific distribution worked on a specific day of the week, such as Monday. The hours worked on Mondays for 6 weeks are 3 hours from 8 a.m., which is calculated as 9%, 3 hours from 9 a.m., which is calculated as 9%, 4 hours from 10 a.m., which is calculated as 13%, 4 hours from 11 a.m., which is calculated as 13%, 5 hours from 12 a.m., which is calculated as 16%, 3.5 hours from 1 p.m., which is calculated as 11%, 2.5 hours from 2 p.m., which is calculated as 8%, 3 hours from 3 p.m., which is calculated as 9%, 2 hours from 4 p.m., which is calculated as 6%, 1 hour from 5 p.m., which is calculated as 3%, and 1 hour from 6 p.m., which is calculated as 3%.

Then, the weight value (Aw) set for each week is applied to the time distribution for each working hour on a specific day of the week. Regarding the weighted value, in order to more importantly evaluate the latest data as described with reference to FIG. 4B, a linear weighted value to which a higher weighted value is given to the recent week among a plurality of weeks may be applied.

FIG. 5B shows an example in which the weighted value (Aw) set for each week is applied to the time distribution for each working hour on a specific day of the week. When the values to which the weighted values (Aw) for each week are applied are summed, the time distribution for each working hour for 6 weeks on Mondays is calculated as 10% at 8 a.m., 10% at 9 a.m., 16% at 10 a.m., 17% at 11 a.m., 11% at 12 a.m., 11% of 115 hours at 1 p.m., 8% at 2 p.m., 8% at 3 p.m., 2% at 4 p.m., 1% at 5 p.m., and 1% at 6 p.m.

Then, based on the distribution for each working hour to which the weighted value (Aw) is applied, the time is allocated for each working hour for each specific day of the week of the following week.

FIG. 5C is a graph illustrating the comparison results before and after application of weighted values (Aw). When the weighted value (Aw) is applied, it is possible to identify a difference in change between 10 a.m. and 12 p.m. and 3 p.m. to 6 p.m. For example, it is possible to allocate time for each working hour for a specific day of the week of the following week by reflecting the trend of time allocation over the last few weeks.

In the above description, operations S110 to S217 may be further divided into additional operations or may be combined into fewer operations, according to an embodiment of the present disclosure. In addition, some operations may be omitted as necessary, and the order among operations may be changed. In addition, even if other contents are omitted, the contents of FIG. 6 to be described later may also be applied to the method for managing a work schedule of each employee automatically of FIGS. 1 to 5C.

Hereinafter, a terminal 100 for managing a work schedule of each employee automatically according to an embodiment of the present disclosure will be described with reference to FIG. 6.

FIG. 6 is a diagram for explaining a terminal 100 for managing a work schedule of each employee automatically according to the present disclosure.

The terminal 100 for managing a work schedule of each employee automatically according to an embodiment of the present disclosure includes a memory 110 and a processor 120.

The memory 110 stores a program for managing a work schedule for the corresponding employee automatically.

The processor 120 executes a program stored in the memory 110. As the processor 120 executes the program stored in the memory 120, the processor 120 reads past work history data for a plurality of weeks of the corresponding employee, predicts total working hours of the following week by summing average weekly working hours and trend adjustment values for the plurality of weeks, allocates the predicted total working hours of the following week for each day of the week based on a time distribution for each day of the week, and allocates the allocated time for each day of the week based on a distribution for each working hour.

The terminal 100 for managing a work schedule of each employee automatically described with reference to FIG. 6 may be provided as a component of the above-described server.

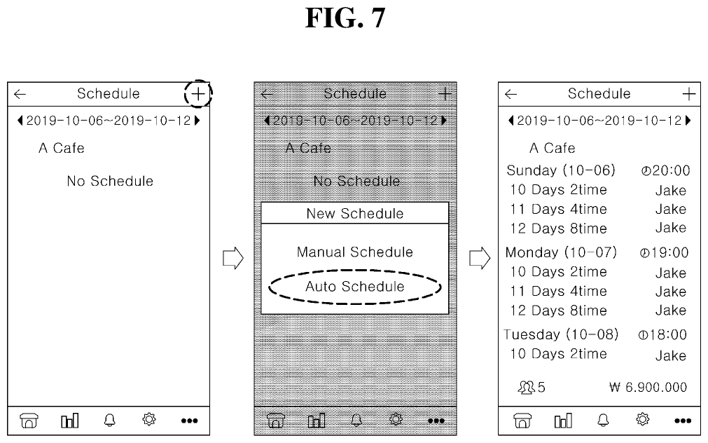

FIG. 7 is a diagram illustrating an example of an application executed in a terminal 100 for managing a work schedule of each employee automatically according to the present disclosure.

According to an embodiment of the present disclosure, by executing an application that is pre-installed in the terminal 100 for managing a work schedule of each employee automatically, a manager may check the working hours of management target employees in a store, working trends and distribution of weighted values only with a single click. It is possible to reserve the schedule for the following week through optimal predictive scheduling with these details applied.

Referring to FIG. 7, the manager selects a store and schedule for scheduling through a login process after executing the application.

Then, when the manager selects the automatic schedule for predictive scheduling, the terminal 100 for managing a work schedule of each employee automatically immediately calculates and provides the predicted scheduling result for each employee through the application.

It goes without saying that the manager may apply the results to the actual schedule of the following week, and some schedules may be manually adjusted. The adjusted data may be used as data for predicting the schedule of the next following week.

As such, managers can quickly and efficiently complete the work scheduling of the following week in less than a minute only with a single click.

The above-mentioned method for managing a work schedule of each employee automatically according to an embodiment of the present disclosure may be implemented with a program (or an application) to be combined with a computer which is hardware and be executed and may be stored in a medium.

For the computer to read the program and execute the methods implemented with the program, the above-mentioned program may include a code encoded into a computer language such as C, C++, Java, Ruby, or a machine language readable through a device interface of the computer by a processor (CPU) of the computer. Such a code may include a functional code associated with a function and the like defining functions necessary for executing the methods and may include a control code associated with an execution procedure necessary for the processor of the computer to execute the functions according to a predetermined procedure. Further, such a code may further include a code associated with memory reference about whether additional information or media necessary for the processor of the computer to execute the functions is referred at any location (address number) of an internal or external memory of the computer. Further, if it is necessary for the processor of the computer to communicate with any computer or server located in a remote place to execute the functions, the code may further include a communication related code about how communication is performed with any computer or server located in a remote place using a communication module of the computer and whether to transmit and receive any information or media upon communication.

The storage medium may refer to a device-readable medium which stores data on a semipermanent basis rather than a medium, such as a register, a cache, or a memory, which stores data during a short moment. In detail, the storage medium may be, for example, but is not limited to, a read only memory (ROM), a random access memory (RAM), a compact disc ROM (CD-ROM), a magnetic tape, a floppy disc, an optical data storage device, or the like. In other words, the program may be stored in various storage media on various servers accessible by the computer or various storage media on the computer of the user. In addition, the medium may be distributed to a computer system connected over a network and may store a computer-readable code on a distributed basis.

The above description of the present disclosure is provided for the purpose of illustration, and it would be understood by those skilled in the technical field to which the present disclosure pertains that various changes and modifications may be made without changing technical ideas or essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A method performed by a terminal for managing a work schedule of each employee automatically, the method comprising:
reading past work history data for a plurality of weeks of a corresponding employee;
predicting total working hours of a following week by summing average weekly working hours and trend adjustment values for the plurality of weeks;
allocating the predicted total working hours of the following week for each day of the week based on a time distribution for each day of the week; and
allocating the allocated time for each day of the week based on a distribution for each working hour.

2. The method of claim 1, wherein the predicting of the total working hours of the following week by summing the average weekly working hours and trend adjustment values for the corresponding employee comprises:
calculating average weekly working hours for a plurality of pre-set past weeks for the corresponding employee;
calculating trend adjustment values based on the total working hours for the plurality of weeks; and
predicting the total working hours of the following week of the corresponding employee by summing the average weekly working hours and the trend adjustment values.

3. The method of claim 2, wherein the calculating of the trend adjustment values based on the total working hours for the plurality of weeks comprises:
calculating a median value by quantifying the plurality of weeks;
calculating a median value of working hours for each week for the plurality of weeks; and
calculating the trend adjustment value based on a least square method (LSM) for each of the calculated median values.

4. The method of claim 3, wherein the calculating of the trend adjustment value based on a least square method (LSM) for each of the calculated median values comprises:
calculating a difference between the median value of the plurality of weeks and a numerical value;
calculating a difference between the median value of the working hours for each week of the plurality of weeks and the working hours for each week; and
calculating the trend adjustment value based on a result of a square operation of a difference between the median value of the plurality of weeks and a numerical value and a result of a multiplication operation of each difference.

5. The method of claim 1, wherein the allocating of the predicted total working hours of the following week for each day of the week based on a time distribution for each day of the week comprises:
calculating a time distribution for each day of the week for the entire plurality of weeks;
applying a weighted value set for each week to the time distribution for each day of the week; and
allocating the predicted total working hours based on the time distribution for each day of the week to which the weighted value is applied.

6. The method of claim 1, wherein the allocating of the allocated time for each day of the week based on a distribution for each working hour comprises:
calculating a time distribution for each working hour for a specific day of the week of the plurality of weeks;
applying a weighted value set for each week to the time distribution for each working hour of the specific day of the week; and
allocating time for each working hour based on the time distribution for each working hour to which the weighted value is applied.

7. The method of claim 5, wherein the weighted value is a weighted value to which a higher weighted value is given to a recent week among the plurality of weeks.

8. A terminal for managing a work schedule of each employee automatically, the terminal comprising:
a memory in which a program for automatically managing a work schedule for the corresponding employee is stored; and
a processor configured to execute a program stored in the memory,
wherein the processor is further configured to:
reading past work history data for a plurality of weeks of a corresponding employee in response to the execution of the program;
predict total working hours of a following week by summing average weekly working hours and trend adjustment values for the plurality of weeks;
allocate the predicted total working hours of the following week for each day of the week based on a time distribution for each day of the week; and
allocate the allocated time for each day of the week based on a distribution for each working hour.

9. The terminal of claim 8, wherein the processor is configured to:
calculate average weekly working hours for a plurality of pre-set past weeks for the corresponding employee;
calculate trend adjustment values based on the total working hours for the plurality of weeks; and
predict the total working hours of the following week of the corresponding employee by summing the average weekly working hours and the trend adjustment values.

10. The terminal of claim 9, wherein the processor is configured to:
calculate a median value by quantifying the plurality of weeks;
calculate a median value of working hours for each week for the plurality of weeks; and
calculate the trend adjustment value based on a least square method (LSM) for each of the calculated median values.

11. The terminal of claim 10, wherein the processor is configured to:
calculate a difference between the median value of the plurality of weeks and a numerical value;
calculate a difference between the median value of the working hours for each week of the plurality of weeks and the working hours for each week; and
calculate the trend adjustment value based on a result of a square operation of a difference between the median value of the plurality of weeks and a numerical value and a result of a multiplication operation of each difference.

12. The terminal of claim 8, wherein the processor is configured to:
calculate a time distribution for each day of the week for the entire plurality of weeks;
apply a weighted value set for each week to the time distribution for each day of the week; and
allocate the predicted total working hours based on the time distribution for each day of the week to which the weighted value is applied.

13. The terminal of claim 8, wherein the processor is configured to:
calculate a time distribution for each working hour for a specific day of the week of the plurality of weeks;
apply a weighted value set for each week to the time distribution for each working hour of the specific day of the week; and
allocate time for each working hour based on the time distribution for each working hour to which the weighted value is applied.

14. The terminal of claim 12, wherein the weighted value is a weighted value to which a higher weighted value is given to a recent week among the plurality of weeks.

15. A computer program combined with a computer and stored in a computer-readable recording medium to execute a method for managing a work schedule of each employee automatically, wherein the program performs operations of:
reading past work history data for a plurality of weeks of a corresponding employee;
predicting total working hours of a following week by summing average weekly working hours and trend adjustment values for the plurality of weeks;
allocating the predicted total working hours of the following week for each day of the week based on a time distribution for each day of the week; and
allocating the allocated time for each day of the week based on a distribution for each working hour.
